(19) United States
(12) Patent Application Publication
(10) Pub. No.: US 2003/0115202 A1
(43) Pub. Date: Jun. 19, 2003

(54) System and method for processing a request using multiple database units

(75) Inventors: Philip C. Jackson JR., Troy, MI (US); Paula Y. Gwyn, Birmingham, MI (US); John C. Joseph, Clarkston, MI (US); Kasra Kasravi, W. Bloomfield, MI (US); Balaji Prasad, Troy, MI (US)

Correspondence Address: BAKER BOTTS L.L.P., 2001 ROSS AVENUE, SUITE 600, DALLAS, TX, 75201-2980, US

(73) Assignee: Electronic Data Systems Corporation

(21) Appl. No.: 10/022,922

(22) Filed: Dec. 17, 2001

(51) Int. Cl. G06F 7/00

(52) U.S. Cl. 707/10

(57) ABSTRACT

A request is processed using one or more database units by receiving a request for a record and communicating the request to one or more nodes. One or more of the nodes is operable to provide an interface between one or more associated database units and a network. Additionally, one or more of the nodes is operable to communicate with each other. The request is further processed by identifying one or more target database units that store the record and accessing the record that is stored in one or more of the target database units. The request is then processed based on the record that is stored in one or more of the target database units such that a response to the request is generated. The response is then returned to the request that is based on the record.

### TECHNICAL FIELD OF THE INVENTION

This invention relates in general to the field of data management, and more particularly to a system and method for processing a request using multiple database units.

### BACKGROUND OF THE INVENTION

The field of data storage has become increasingly important in today's society. Data storage generally involves a database representing a collection of information organized in a way that allows someone or something to access desired pieces of information. One aspect of data storage relates to data management, which generally relates to organizing and accessing information stored in a given database. Data management architectures generally facilitate the retrieval of information or records stored in any one of a number of databases. Additionally, data management architectures may operate to store, to modify, and to update, information in a given database. The operation of such data management architectures continues to grow more challenging as databases grow in size, i.e. the amount of information being stored or maintained in the database.

In order to enable access to data by users or systems at different locations, and to further ensure that data is not lost due to any number of reasons, such as accidents, catastrophes, or operational failures for example, multiple copies of data may need to be effectively managed, maintained, and kept current in certain circumstances.

### SUMMARY OF THE INVENTION

From the foregoing, it may be appreciated by those skilled in the art that a need has arisen for an improved data management system for processing a request using multiple database units. In accordance with one embodiment of the present invention, a system and method for processing a request using multiple database units are provided which substantially eliminate or reduce disadvantages and problems of conventional data management techniques.

According to one embodiment of the present invention, a method for processing a request using multiple database units comprises receiving a request for a record and communicating the request to one or more nodes. One or more of the nodes is operable to provide an interface between one or more associated database units and a network. Additionally, one or more of the nodes is operable to communicate with each other. The method further includes identifying one or more target database units that store the record and accessing the record that is stored in one or more of the target database units. The request is then processed based on the record that is stored in one or more of the target database units such that a response to the request is generated. The response is then returned to the request, the response being based on the record that is stored in one or more of the target database units.

Certain embodiments of the present invention provide a number of technical advantages. For example, according to one embodiment of the present invention, a method for processing a request using multiple database units is disclosed that provides the benefits of redundancy and failover (i.e. a backup or standby protocol) in data storage. This is due, in part, to the apportionment of information among several database units coupled to a network. Thus, in the scenario where a single database unit is inoperable for whatever reason, this deficiency does not affect data storage or retrieval of records in other database units.

Additionally, according to the teachings of the present invention a method for processing a request using multiple database units is provided that offers the benefit of increased capacity. The increased capacity is a result of the use of several databases implemented to replace the use of a single database that is restricted or otherwise constrained by its architecture or size.

The embodiments, which follow, may enjoy some, all, or none of these advantages. Other technical advantages may be readily apparent to one skilled in the art from the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts in which:

FIG. 1 is a block diagram of a data management system illustrating a request that is processed using multiple database units coupled to a network; and

FIG. 2 is a flowchart illustrating a series of steps associated with processing a request with multiple database units that are coupled to a network.

### DETAILED DESCRIPTION OF THE INVENTION

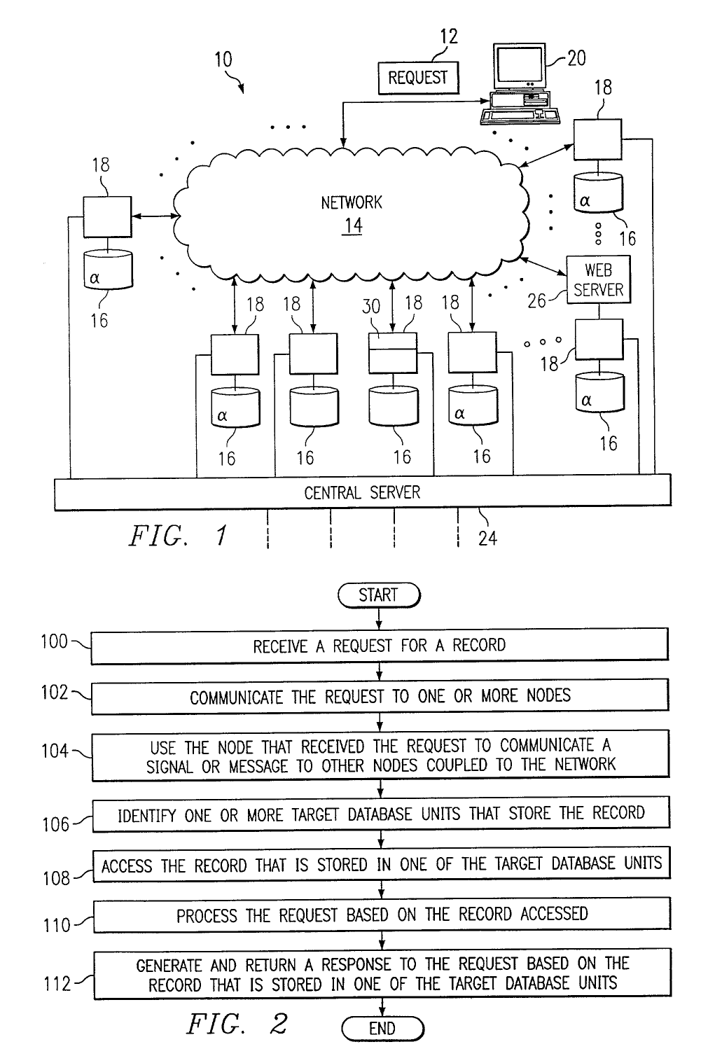

FIG. 1 is a block diagram of a data management system 10 illustrating a request 12 that may be processed using multiple database units 16 coupled to a network 14. Each database unit 16 is coupled to an associated node 18, each of the nodes being operable to communicate with each other in order to access a record stored in any one or several database units 16. The record that is stored in database units 16 may be generally accessed in order to satisfy request 12 with a suitable response. FIG. 1 also illustrates a terminal 20 that generates request 12 to be processed in network 14.

According to the teachings of the present invention, data management system 10 operates to process request 12 by querying all nodes 18 for the location of a record that satisfies request 12. After a location for the desired record is identified, these locations may be accessed via communications between nodes 18 and network 14, such that a response to request 12 may be generated and returned to terminal 20. The distribution of data or records amongst database units 16 provides the ability to store a large amount of data that may be accessed via any one of nodes 18. Additionally, the use of several database units 16, which may communicate using suitable peer-to-peer technology, provides failover (i.e. a backup or standby protocol) and redundancy capabilities to data management system 10 without hindering performance characteristics of an associated database coupled to network 14. Moreover, data management system 10 may provide support in a large distributed database environment, for example, offering replication of data over any number of platforms, protocols, or architectures.

Request 12 is a request generated by a user of terminal 20 that is seeking to access a record entitled ‘α.’ (may reside or be otherwise stored in any number of database units 16.) Alternatively, request 12 could be any interface, computer, server, device, element, or object (or any resultant generated by these elements) operable to communicate a request for a record or for data to network 14. Request 12 is communicated to network 14 where it may then be passed to any one of nodes 18 in an effort to retrieve record α and to further facilitate a response to be returned to terminal 20. Request 12 may include commands or signals for additional operations, other than retrieval, to be performed on record α. Such operations may include print, modify, or delete, for example, or any other suitable operation (inclusive of any number of structured query language (SQL) commands) according to particular needs. Request 12 may be communicated over any appropriate network connection, inclusive of wireless communications, to network 14.

Network 14 is a world wide web network in one embodiment, providing an interface between nodes 18 and terminal 20. Network 14 may communicate with one or more nodes 18 or with one or more database units 16 in any manner, including hub-and-spoke, peer-to-peer, or any other suitable protocol. In particular embodiments, network 14 may include one or more engines or other applications that provide communication services or capabilities to a user of terminal 20. Network 14 may comprise one or more local area networks (LANs), metropolitan area networks (MANs), wide area networks (WANs), and/or any other appropriate internets, intranets, or wireless architectures where appropriate. Network 14 may by coupled to one or more database units 16, via one or more associated nodes 18.

Database units 16 represent storage mediums that may comprise a collection of information for data storage. The term “data storage” is used to refer to any appropriate data source, representation of data, or other organization of data. The data storage within database units 16 may be hierarchical in nature and/or may provide persistent data storage for data management system 10. For example, database units 16 may be a multi-dimensional database that stores data in a hierarchical and multidimensional format or database units 16 may be a representation of data derived by a server or other appropriate component from data stored in a relational database, in memory, or in any other appropriate location or component. Database units 16 may communicate with each other via network 14, nodes 18, or any suitable link operable to exchange information, data or signals. In addition, database units 16 may be coupled to a mainframe, additional networks, or other communications devices or elements where appropriate.

Database units 16 may comprise redundant information, i.e. information that is included in several of database units 16, or alternatively different versions of a record (based on time-stamping or modifications, for example). This redundancy characteristic is illustrated generally in FIG. 1 by record α as included within several database units 16. Because database units 16 are also capable of storing records or data that is not included in peer database units 16, a greater capacity for storing information is provided in data management system 10. Database units 16 may store a single record, a portion of a record, or millions of records according to the teachings of the present invention. Database units 16 may be coupled to any device, interface, or component operable to facilitate communications from network 14. In an alternative embodiment, database units 16 may be included within network 14. The term “target database unit” refers to one or more database units 16 that contain or otherwise store a record queried for by request 12. The target database unit 16 is used in generating an appropriate response to request 12. Database units 16 are each coupled to an associated node 18.

Nodes 18 represent a location for receiving request 12, and may further facilitate the retrieval of request 12 from one or more database units 16. Nodes 18 may be an interface, a computer or any other object or element operable to facilitate a communication between network 14 and database units 16. Alternatively, nodes 18 may be coupled to network 14 using one or more local area networks (LANs), metropolitan area networks (MANs), wide area networks (WANs), a global computer network such as the Internet, and/or any other appropriate wireline, wireless, or other links. Additionally, one or more nodes 18 may comprise an application program interface (API) operable to provide a set of routines, operations, protocols, or tools for facilitating a communication between database units 16 and network 14. An API may also provide the ability for various formats, types, or variations of request 12 to be received and processed by network 14. In one embodiment, nodes 18 are included within associated database units 16. Alternatively, nodes 18 may be included in network 14, facilitating communications between an associated database unit 16 and network 14.

Nodes 18 may operate to perform or otherwise facilitate some operation associated with request 12 such as print, copy, delete, or modify, for example, or any other suitable operation associated with request 12 according to particular needs. In the case where operations are performed on request 12, potentially at nodes 18 or alternatively within database units 16, one or more nodes 18 may broadcast the operations to be performed to devices or elements within data management system 10, or alternatively may retrieve the appropriate record (for example record a) and perform the requisite operation on the record before returning it to a suitable location. In the scenario in which one or more nodes 18 perform operations to a given record, an updated copy of the record may be optionally returned to all locations that include the record, or only some locations (that may or may not have included the record) where appropriate and according to particular needs.

There are a variety of ways (as described below) in which one or more nodes 18 may communicate messages or appropriate signals to other nodes 18 or database units 16 such that a targeted record is retrieved and used to satisfy request 12. For example, request 12 may be ported from one node 18 to another in a peer to peer or in a tic-tack fashion such that each node 18 is queried for the record corresponding to request 12. Additionally, node 18 may communicate with every other node 18 coupled to network 14 such that a response to request 12 may be generated based on the record retrieved.

In one embodiment of the present invention, nodes 18 each include an index 30 that comprises a list of information associated with the location of all nodes 18, database units 16, and records within network 14. Additionally, the index may include location information associated with records within each of database units 16. This index implementation would provide for the efficient routing and retrieval of a record being queried by request 12. Index 30 may alternatively include a list of potential operations that may or may not be performed by various nodes 18 or database units 16. This may allow request 12 to be directed to a proper node 18 for suitable processing before generating an appropriate response to request 12.

In another embodiment of the present invention, one or more nodes 18 may be operable to communicate with a central server 24. Central server 24 may be coupled to nodes 18, database units 16, or network 14. Central server 24 may comprise a table, chart, index, or listing that includes information associated with the location or distribution of one or more records within one or more database units 16. Request 12 may be routed directly to central server 24 or alternatively directed to network 14 and through nodes 18 before reaching central server 24. Alternatively, request 12 may be communicated to a web server 26 (described below) or communicated to any other suitable component in any appropriate manner according to particular needs. Central server 24 may receive request 12 and identify where the appropriate record is found in one or more target database units 16. Central server 24 may then directly access the record queried for or alternatively pass request 12 onto the proper node 18 associated with a target database unit 16 for further processing. Alternatively, central server 24 may be eliminated entirely, whereby request 12 is directly routed to any one of nodes 18.

In yet another embodiment, each node 18 includes a unique address to be used in conjunction with a hashing algorithm. The hashing algorithm may be included anywhere in data management system 10 (for example in index 30, in place thereof, or alternatively included in each node 18) to be utilized in directing request 12. Given the information contained in a record being sought, the hashing algorithm may compute or otherwise determine the address of the node(s) that store the record. Accordingly, one or more nodes 18 or one or more web servers 26 may implement a hashing algorithm in order to direct request 12 to proper locations in order to retrieve a record that may satisfy request 12.

In one embodiment, one or more nodes 18 are coupled to web server 26 via a link which may be any wireline, wireless, or other link suitable operable to support data communications between web server 26 and node 18 during operation of data management system 10. Although a link is shown as generally coupling web server 26 to network 14, the present insertion contemplates that network 14 may communicate directly with one or more corresponding database units 16 where one or more web servers 26 are included within one or more database units 16. One or more nodes 18, as well as one or more database units 16, may be integral to or separate from one or more web servers 26, may operate on one or more computers, and may store any information suitable to support the operation of data management system 10 in facilitating a response to request 12. Additionally, a series of one or more web servers 26 may be coupled to (indirectly or directly) database units 16, resulting in a web server farm architecture. In this scenario, request 12 may be received by one or more web servers 26 from network 14. Nodes 18 may communicate with web servers 26 such that target database units 16 may be accessed in order to obtain or otherwise retrieve a record queried for by request 12.

Terminal 20 is a computer operable to generate request 12 to be communicated to network 14. As used in this document, the term “computer” is intended to encompass a personal computer, workstation, network computer, wireless data port, wireless telephone, personal digital assistant, one or more microprocessors within these or other devices, a computer interface, a computer program, or any other suitable processing device that is operable to generate request 12. Terminal 20 may be coupled to network 14 using one or more local area networks (LANs), metropolitan area networks (MANs), wide area networks (WANs), and/or any other appropriate wireline, wireless, or other links.

Terminal 20 may include a suitable input device, such as a keypad, mouse, touch screen, microphone, or other device operable to input information. An output device coupled to terminal 20 may convey information associated with the operation of data management system 10, including digital or analog data, visual information, or audio information. Terminal 20 may additionally include one or more processors, programs, and associated memory to execute instructions and manipulate information or records within database units 16 according to the operation of data management system 10. Although only a single terminal 20 is shown, a host of terminals may be coupled to network 14 that seek to retrieve a given record stored on one or more database units 16. These terminals 20 may each operate on separate computers or operate on one or more shared computers. Each of the one or more terminals 20 may be a work station, personal computer (PC), network computer, personal digital assistant (PDA), wireless data port, or any other suitable computing device.

FIG. 2 is a flowchart illustrating a series of steps associated with processing request 12 with multiple database units 16 coupled to network 14. The method begins at step 100 where terminal 20 generates request 12 and communicates it to network 14. At step 102 request 12 is communicated by network 14 to any one of nodes 18 or an associated web server 26. The node 18, or optionally web server 26, that receives request 12 may then communicate request 12 (illustrated at step 104) to other nodes 18 or other web servers 26 in a random fashion or specifically to targeted nodes based on, for example, information contained in index 30. Alternatively, node 18 or web server 26 receiving request 12 may utilize a hashing algorithm to determine where a specific piece of information is stored in any one of database units 16. In addition, node 18 or web server 26 receiving request 12 may query central server 24 for the location of information or a record sought by request 12. In identifying the requisite information, any one of a number of components or elements within data management system 10 may operate to determine time-stamp information or any other data characteristic indicating or distinguishing information of records that are stored in any one of database units 16. In this manner, the most recent updated copy of a record may be determined and located. This identification of a proper location or target database unit 16 and storing the record sought to be retrieved or otherwise accessed is illustrated generally at step 106.

The relevant record or data stored in a targeted database unit 16 may then be accessed or retrieved by central server 24, any one or more of nodes 18, web server 26, or network 14. This access or retrieval step is illustrated generally at step 108. At step 110, request 12 may then be processed and may include a simple communication of a record potentially flowing back through network 14 and to terminal 20. Alternatively, the processing of request 12 may include web server 26, central server 24, or any one of nodes 18 performing some operation on request 12 in order to generate a suitable response. These operations are described above with reference to FIG. 1.

Once request 12 is processed, any one of the components or elements within data management system 10 may then return the record to one or more of database units 16. This information may be updated to reflect the operations performed or alternatively this information may be returned in its original format or structure to any database unit 16. At step 112, a response to request 12 is generated and returned to network 14. The response is based on the information accessed by data management system 10 stored in database units 16. Network 14 may then return the response to terminal 20 or alternatively further process the response before returning a result to terminal 20.

The present invention may be used in a host of communications environments that facilitate data storage. For example, data management system 10 may be used in wireless communication systems, asynchronous transfer mode (ATM) applications, firewall applications, e-commerce environments, or any other field or area where data storage may be implemented. Additionally, although the present invention has been described with reference to web server 26, central server 24, and terminal 20, a myriad of potential devices, interfaces, hardware, software, components, structure, and elements may be used in conjunction with the present invention to facilitate data storage. These objects may be coupled to or contained within network 14, or alternatively coupled to any other component within data management system 10, such as database units 16 or nodes 18, for example.

In addition, the present invention may be configured such that a database management system is provided at each of nodes 18, i.e., it may be a distributed database management system. Numerous other changes, substitutions, variations, alterations, and modifications may be suggested to one skilled in the art and it is intended that the present invention encompass all such changes, substitutions, variations, alterations, and modifications as falling within the spirit and scope of the appended claims.

What is claimed is:

1. A method for processing a request using one or more database units coupled to a network, comprising:
receiving a request for a record;
communicating the request to one or more nodes, wherein one or more of the nodes is operable to provide an interface between one or more associated database units and a network, and wherein one or more of the nodes is operable to communicate with each other;
identifying one or more target database units that store the record;
accessing the record, which is stored in one or more of the target database units;
processing the request based on the record that is stored in one or more of the target database units such that a response to the request is generated; and
returning the response to the request that is based on the record, which is stored in one or more of the target database units.

2. The method of claim 1, wherein identifying comprises using a hashing algorithm to identify a location of the record within one or more of the target database units.

3. The method of claim 1, further comprising querying one or more of the nodes for data relating to an age characteristic associated with the record.

4. The method of claim 1, further comprising providing an index in at least one of the nodes, the index comprising information associated with locations of one or more records, wherein one or more of the nodes may access the index to identify one or more of the target database units that store the record.

5. The method of claim 1, wherein processing comprises performing an operation on the record that facilitates generation of the response, each of the nodes being operable to perform the operation and the operation being selected from the group consisting of:
a) modifying;
b) deleting;
c) copying;
d) printing; and
e) structured query language (SQL) commands.

6. The method of claim 5, further comprising communicating an updated record after the operation is performed on the record to one or more of the target database units.

7. The method of claim 1, wherein identifying comprises employing a central server to identify the target database units, the central server comprising information indicating the location of one or more records that are included within one or more of the database units.

8. The method of claim 1, further comprising coupling one or more web servers to one or more of the nodes, the web servers facilitating communications between the network and one or more of the database units.

9. Software embodied in a computer readable media for processing a request using one or more database units coupled to a network, the software operable to:
receive a request for a record;
communicate the request to one or more nodes, wherein one or more of the nodes is operable to provide an interface between one or more associated database units and a network, and wherein one or more of the nodes is operable to communicate with each other;
identify one or more target database units that store the record;
access the record, which is stored in one or more of the target database units;
process the request based on the record that is stored in one or more of the target database units such that a response to the request is generated; and
return the response to the request that is based on the record, which is stored in one or more of the target database units.

10. The software of claim 9, further operable to use a hashing algorithm to identify a location of the record within one or more of the target database units.

11. The software of claim 9, further operable to query one or more of the nodes for data relating to an age characteristic associated with the record.

12. The software of claim 9, further operable to provide an index, the index comprising information associated with locations of one or more records, wherein one or more of the nodes may access the index to identify one or more of the target database units that store the record.

13. The software of claim 9, further operable to perform an operation on the record that facilitates generation of the response, each of the nodes including software operable to perform the operation, the operation being selected from the group consisting of:
a) modifying;
b) deleting;
c) copying;
d) printing; and
e) structured query language (SQL) commands.

14. The software of claim 13, further operable to communicate an updated record after the operation is performed on the record to one or more of the target database units.

15. The software of claim 9, further operable to employ a central server to identify the target database units, the central server comprising information indicating the location of one or more records that are included within one or more of the database units.

16. The software of claim 9, further operable to couple one or more web servers to one or more of the nodes, the web servers facilitating communications between the network and one or more of the database units.

17. A system for processing a request using one or more database units coupled to a network, comprising:
means for receiving a request for a record;
means for communicating the request to one or more nodes, wherein one or more of the nodes is operable to provide an interface between one or more associated database units and a network, and wherein one or more of the nodes is operable to communicate with each other;
means for identifying one or more target database units that store the record;
means for accessing the record, which is stored in one or more of the target database units;
means for processing the request based on the record that is stored in one or more of the target database units such that a response to the request is generated; and
means for returning the response to the request that is based on the record that is stored in one or more of the target database units.

18. The system of claim 17, wherein the means for identifying comprises means for using a hashing algorithm to identify a location of the record within one or more of the target database units.

19. The system of claim 17, further comprising means for querying one or more of the nodes for data relating to an age characteristic associated with the record.

20. The system of claim 17, further comprising means for providing an index in at least one of the nodes, the index comprising information associated with locations of one or more records, wherein one or more of the nodes may access the index to identify one or more of the target database units that store the record.

21. The system of claim 17, wherein the means for processing comprises means for performing an operation on the record that facilitates generation of the response, each of the nodes being operable to perform the operation, the operation being selected from the group consisting of:
a) modifying;
b) deleting;
c) copying;
d) printing; and
e) structured query language (SQL) commands.

22. The system of claim 21, further comprising means for communicating an updated record after the operation is performed on the record to one or more of the target database units.

23. The system of claim 17, wherein the means for identifying comprises means for employing a central server to identify the target database units, the central server comprising information indicating the location of one or more records that are included within one or more of the database units.

24. The system of claim 17, further comprising means for coupling one or more web servers to one or more of the nodes, the web servers facilitating communications between the network and one or more of the database units.

25. An apparatus for processing a request using one or more database units coupled to a network, comprising:
one or more database units coupled to a network; and
one or more nodes, each of the nodes being coupled to a respective database unit and operable to receive a request for a record, one or more of the nodes also being operable to provide an interface between one or more of the database units and the network and to communicate with each other to identify one or more target database units that store the record, wherein the target database units may be accessed by one or more of the nodes to process the record that is stored in one of the target database units such that a response to the request is generated.

26. The apparatus of claim 25, wherein one or more of the nodes comprises a hashing algorithm operable to identify a location of the record within one or more of the target database units.

27. The apparatus of claim 25, wherein one or more of the nodes comprises an index operable to identify an age characteristic associated with the record and to identify a location of the record.

28. The apparatus of claim 25, wherein one or more of the nodes are further operable to perform an operation on the record that facilitates generation of the response, and wherein the operation is selected from the group consisting of:
a) modifying;
b) deleting;
c) copying;
d) printing; and
e) structured query language (SQL) commands.

29. The apparatus of claim 28, wherein one or more of the nodes are further operable to communicate an updated record after the operation is performed on the record to one or more of the database units.

30. The apparatus of claim 25, further comprising a central server coupled to one or more of the nodes and operable to identify the target database units, wherein the central server comprises information indicating the location of one or more records included within one or more of the database units.

31. The apparatus of claim 25, further comprising one or more web servers coupled to one or more of the nodes and operable to facilitate communications between the network and one or more of the database units.
